(19) United States
(12) Patent Application Publication
(10) Pub. No.: US 2002/0071088 A1
(43) Pub. Date: Jun. 13, 2002

(54) Pair of safety glasses utilizing hinged protective lenses

(76) Inventor: Bobby R. Cardenas, Fremont, CA (US)

Correspondence Address: Richard W. Goldstein, 2071 Clove Road, Staten Island, NY, 10304, US

(21) Appl. No.: 09/735,045

(22) Filed: Dec. 13, 2000

(51) Int. Cl. G02C 7/08

(52) U.S. Cl. 351/57; 351/58

(57) ABSTRACT

A pair of safety glasses utilizing hinged protective lenses including a frame member comprised of a brow support having a pair of rearwardly extending ear supports. A protective shield is hingedly coupled with the brow support of the frame member. The protective shield is dimensioned for covering the eyes of the user.

### BACKGROUND OF THE INVENTION

The present invention relates to a pair of safety glasses utilizing hinged protective lenses and more particularly pertains to allowing a user to flip up the protective lenses when not in use to have better vision.

Many people utilize safety goggles when performing tasks that present some type of risk of injury to their eyes. The safety goggles have protective lenses that will protect the user's eyes from any spraying debris or the like. The typical pair of safety goggles have lenses that are constructed of a rigid transparent plastic that will allow the person to safely work and see at the same time. Unfortunately, after continuous use, the lenses sometimes become difficult to see through. The result has people removing the safety goggles when not in a dangerous situation in order to see better whereby they are prone to misplacing the goggles. What is needed is a way for people to wear safety goggles such that the lenses can be removed in a non dangerous situation in order to see better.

The present invention attempts to solve the abovementioned problem by providing a pair of safety glasses that have lenses that are hingedly coupled with the frame whereby the lenses can be raised when needed to see more clearly.

The use of safety devices is known in the prior art. More specifically, safety devices heretofore devised and utilized for the purpose of protecting the wearer are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,471,679 to Paoluccio discloses a face protector comprised of a clear plastic face shield attached to a pair of glassless temple frames. U.S. Pat. No. 4,304,469 to Solomon discloses a pair of eyeglasses with removable lenses for use with interchangeable prescription or safety glasses. U.S. Pat. No. 5,428,407 to Sheffield discloses means for attaching prescription lenses to a pair of safety glasses. U.S. Pat. No. 4,796,986 to Gowdy, Jr. discloses a pair of safety glasses combined with prescription glasses.

While these devices fulfill their respective, particular objective and requirements, the aforementioned patents do not describe a pair of safety glasses utilizing hinged protective lenses for allowing a user to flip up the protective lenses when not in use to have better vision.

In this respect, the pair of safety glasses utilizing hinged protective lenses according to the present invention substantially departs from the conventional concepts and designs of the prior art, and in doing so provides an apparatus primarily developed for the purpose of allowing a user to flip up the protective lenses when not in use to have better vision.

Therefore, it can be appreciated that there exists a continuing need for a new and improved pair of safety glasses utilizing hinged protective lenses which can be used for allowing a user to flip up the protective lenses when not in use to have better vision. In this regard, the present invention substantially fulfills this need.

### SUMMARY OF THE INVENTION

In the view of the foregoing disadvantages inherent in the known types of safety devices now present in the prior art, the present invention provides an improved pair of safety glasses utilizing hinged protective lenses. As such, the general purpose of the present invention, which will be described subsequently in greater detail, is to provide a new and improved pair of safety glasses utilizing hinged protective lenses which has all the advantages of the prior art and none of the disadvantages.

To attain this, the present invention essentially comprises a frame member comprised of a brow support having a pair of rearwardly extending ear supports. A protective shield is hingedly coupled with the brow support of the frame member. The protective shield is dimensioned for covering the eyes of the user. The protective shield has an upper edge, a lower edge, and opposed side edges. The upper edge is coupled with the brow support of the frame member by a plurality of spring loaded hinges. The protective shield includes a nose recess extending upwardly of the lower edge for receiving a nose of the user therein. The protective shield includes a pair of rearwardly extending side shields disposed on the opposed side edges thereof.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved pair of safety glasses utilizing hinged protective lenses which has all the advantages of the prior art safety devices and none of the disadvantages.

It is another object of the present invention to provide a new and improved pair of safety glasses utilizing hinged protective lenses which may be easily and efficiently manufactured and marketed.

It is a further object of the present invention to provide a new and improved pair of safety glasses utilizing hinged protective lenses which is of durable and reliable construction.

An even further object of the present invention is to provide a new and improved pair of safety glasses utilizing hinged protective lenses which is susceptible of a low cost of manufacture with regard to both materials and labor, and which accordingly is then susceptible of low prices of sale to the consuming public, thereby making such a pair of safety glasses utilizing hinged protective lenses economically available to the buying public.

Even still another object of the present invention is to provide a new and improved pair of safety glasses utilizing hinged protective lenses for allowing a user to flip up the protective lenses when not in use to have better vision.

Lastly, it is an object of the present invention to provide a new and improved pair of safety glasses utilizing hinged protective lenses including a frame member comprised of a brow support having a pair of rearwardly extending ear supports. A protective shield is hingedly coupled with the brow support of the frame member. The protective shield is dimensioned for covering the eyes of the user.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the pair of safety glasses utilizing hinged protective lenses constructed in accordance with the principles of the present invention.

FIG. 2 is a front view of the present invention illustrated in use with the lenses in a lowered orientation.

FIG. 3 is a front view of the present invention illustrated in use with the lenses in a raised orientation.

The same reference numerals refer to the same parts through the various figures.

### DESCRIPTION OF THE PREFERRED EMBODIMENT

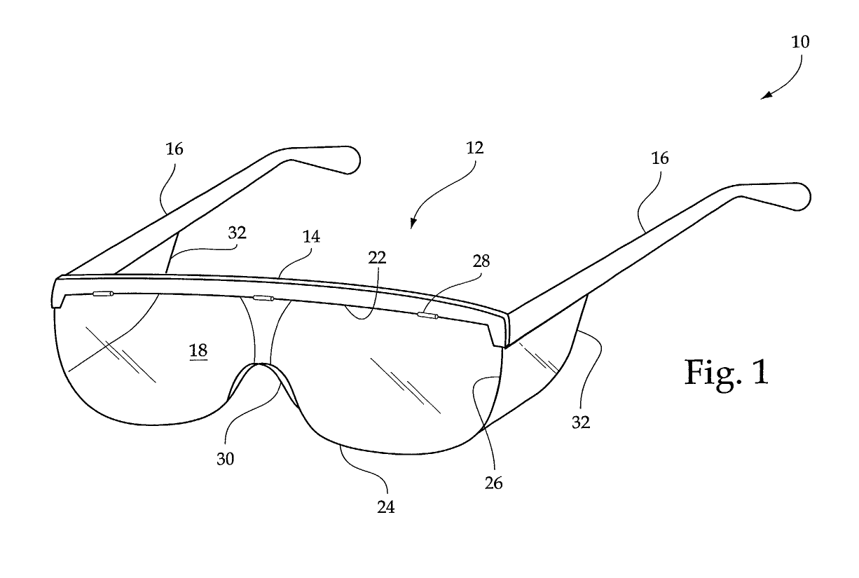

With reference now to the drawings, and in particular, to FIGS. 1 through 3 thereof, the preferred embodiment of the new and improved pair of safety glasses utilizing hinged protective lenses embodying the principles and concepts of the present invention and generally designated by the reference number 10 will be described.

Specifically, it will be noted in the various figures that the device relates to a pair of safety glasses utilizing hinged protective lenses for allowing a user to flip up the protective lenses when not in use to have better vision. In its broadest context, the device consists of a frame member and a protective shield. Such components are individually configured and correlated with respect to each other so as to attain the desired objective.

The frame member 12 is comprised of a brow support 14 having a pair of rearwardly extending ear supports 16. The frame member 12 is identical to that of a pair of standard eyeglass frames.

The protective shield 18 is hingedly coupled with the brow support 14 of the frame member 12. The protective shield 18 is dimensioned for covering the eyes 20 of the user. The protective shield 18 has an upper edge 22, a lower edge 24, and opposed side edges 26. The upper edge 22 is coupled with the brow support 14 of the frame member 12 by a plurality of spring loaded hinges 28. The protective shield 18 includes a nose recess 30 extending upwardly of the lower edge 24 for receiving a nose of the user therein. The protective shield 18 includes a pair of rearwardly extending side shields 32 disposed on the opposed side edges 26 thereof.

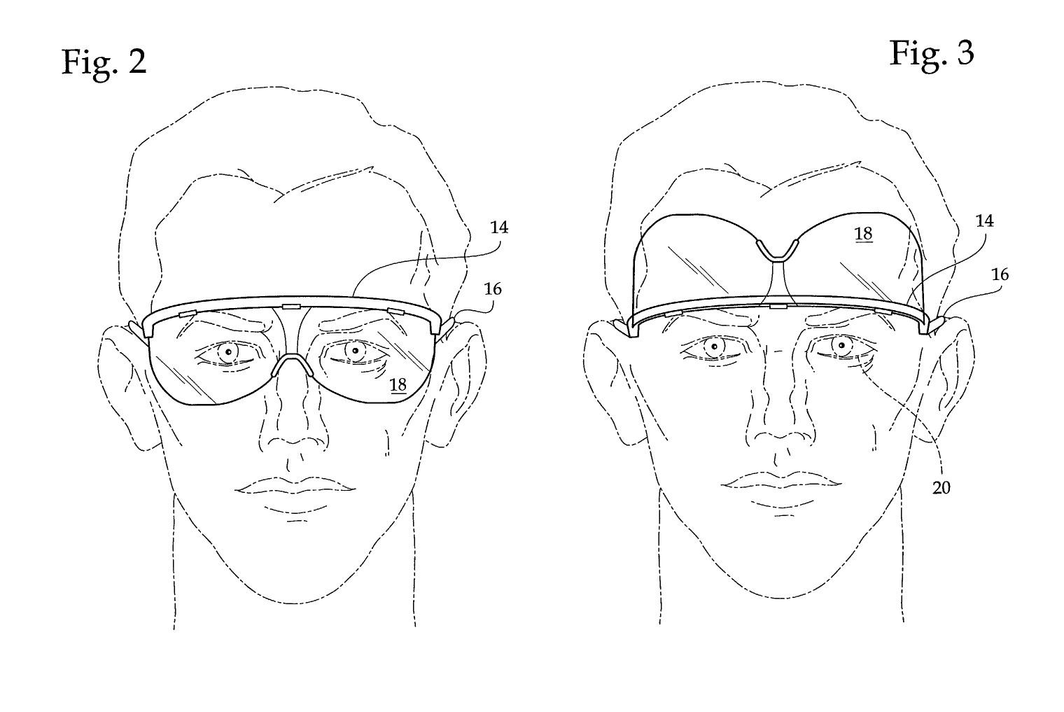

In use, the wearer will position the frame member 12 on their face in the normal manner. When working, or present in a dangerous situation, the protective shield 18 will be positioned in a lowered orientation, as in FIG. 2, to protect the eyes 20. When in a non-dangerous situation, the protective shield 18 can be raised, as in FIG. 3, to expose the eyes 20 thereby making visibility better.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by LETTERS PATENT of the United States is as follows:

1. A pair of safety glasses utilizing hinged protective lenses for allowing a user to flip up the protective lenses when not in use to expose their eyes to have better vision comprising, in combination:
a frame member comprised of a brow support having a pair of rearwardly extending ear supports;
a protective shield hingedly coupled with the brow support of the frame member, the protective shield being dimensioned for covering the eyes of the user, the protective shield having an upper edge, a lower edge, and opposed side edges, the upper edge being coupled with the brow support of the frame member by a plurality of spring loaded hinges, the protective shield including a nose recess extending upwardly of the lower edge for receiving a nose of the user therein, the protective shield including a pair of rearwardly extending side shields disposed on the opposed side edges thereof.

2. A pair of safety glasses utilizing hinged protective lenses for allowing a user to flip up the protective lenses when not in use to expose their eyes to have better vision comprising, in combination:
a frame member comprised of a brow support having a pair of rearwardly extending ear supports;
a protective shield hingedly coupled with the brow support of the frame member, the protective shield being dimensioned for covering the eyes of the user.

3. The pair of safety glasses utilizing hinged protective lenses as set forth in claim 2, wherein the protective shield has an upper edge, a lower edge, and opposed side edges, the upper edge being coupled with the brow support of the frame member by a plurality of spring loaded hinges.

4. The pair of safety glasses utilizing hinged protective lenses as set forth in claim 3, wherein the protective shield including a nose recess extending upwardly of the lower edge for receiving a nose of the user therein.

5. The pair of safety glasses utilizing hinged protective lenses as set forth in claim 3, wherein the protective shield includes a pair of rearwardly extending side shields disposed on the opposed side edges thereof.
